(19) United States
(12) Patent Application Publication
(10) Pub. No.: US 2012/0300059 A1
(43) Pub. Date: Nov. 29, 2012

(54) Method to inspect components of a wind turbine

(76) Inventor: Jason Stege, Brande (DK)

(21) Appl. No.: 13/472,602

(22) Filed: May 16, 2012

(30) Foreign Application Priority Data
May 25, 2011 (EP) EP11167447

(51) Int. Cl. H04N 7/18

(52) U.S. Cl. 348/114; 348/E07.085

(57) ABSTRACT

An unmanned aerial vehicle is guided to the component for the inspection. A certain predefined distance between the unmanned aerial vehicle and the component is chosen in a way that high resolution images of the component are gathered by the unmanned aerial vehicle. The images are gathered by an image acquisition system. The inspection is done remote controlled and based on the images, which are gathered by the unmanned aerial vehicle.

### CROSS REFERENCE TO RELATED APPLICATIONS

This application claims priority of European Patent Office application No. 11167447.9 EP filed May 25, 2011. All of the applications are incorporated by reference herein in their entirety.

### FIELD OF INVENTION

A method to inspect components of a wind turbine is provided.

### BACKGROUND OF INVENTION

Wind turbines and their components like blades are inspected by service technicians regularly. They have to look for damages, which are caused by fatigue-loads for example. They even have to look for rust and oxidation damages, for damages due to environmental impacts like lightning strikes and hail or for damages caused by environmental conditions like ice, temperature-differences, etc.

### SUMMARY OF INVENTION

Highly specialized technicians need for a quick check between two and six hours, thus this work is tedious and quite expensive.

Additionally the technician has to climb up to the component for the inspection. Thus there is a high accident-risk for the technician while he is working.

An improved method to inspect components of a wind turbine, especially usable to check blades of the wind turbine is provided

According to the method a so called “Unmanned Aerial Vehicle, UAV” is guided to the component, which needs to be inspected. A certain predefined distance between the UAV and the component is chosen in a way that high resolution images (like pictures or maps) of the component may be gathered by the UAV. The images are gathered by help of an image acquisition system, which is an arranged aside the UAV. Thus the inspection is done remote controlled and is based on the images, being gathered by the UAV.

The UAV may carry at least components of the image acquisition system or the whole image acquisition system.

The needed load capacity of the UAV may be reduced if only components of the image acquisition system are carried by the UAV. Thus costs may be reduced by reducing the size of the UAV being used.

An optical camera system or an ultrasonic system or a high-frequency system or an infrared camera system or a thermal camera system or another (remote-controlled) system, which is prepared to generate and gather images, may be used as image acquisition system.

Some of those systems are well known from the consumer market and are thus quite cheap, small and they are even lightweight. Thus they may be moved and carried by an appropriate chosen UAV without problems.

The acquired images or resulting image-data may be transferred and stored in a central database. This allows a subsequent inspection of the components after the inspection is done.

The transfer of the images or data may be done wireless. All gathered images or image-data are transferred in real time towards used tools of the technician.

Weight is reduced asides the UAV as there is no longer the need for a database on board of the UAV. Gathered information is stored in real time and independent from the UAV being used.

Even the documentation of the components and of the inspection is done by use of the database quite easily and with a small amount of post-work needed.

The documentation may be done as automated-self-documentation, for example, using an appropriate computer program.

The method provides that only one technician or only one operator is required during the inspection-period. Thus the inspection-procedure is time efficient and cheap.

The method provides that the technician stays on the ground of the wind turbine while the inspection-procedure is done. Thus the accident risk for the technician is quite low. There is no longer the need for the technician to climb up to the component of the wind turbine (like a blade) while the inspection is done.

The UAV takes off, navigates to the surface of the component like the blade and lands autonomously, being remote controlled by appropriate software.

The software may use GPS-data for the remote control of the UAV. Thus the operator is able to command and to return the UAV to any predetermined or previous position on its flight path. Thus the images may be improved stepwise if needed.

A computer may be arranged asides the UAV. The computer is prepared to recognize damages asides the component automatically via the gathered images or image-data.

The detected damages may be highlighted within an image-stream or within a video, which is transferred to the technician on the ground.

The UAV may record a high definition video of the entire flight. If a damage is detected the UAV flies preferably and automatically close to the component. Thus a close look is allowed while high resolution images of the damage are generated.

Data of visual image(s) may be transferred to a laptop used by the technician for the inspection. The technician determines if detected damages are serious or not. The damages are saved within an inspection-report automatically.

Portions of the image-data may be saved to a central database automatically and according to a set of predefined rules. These data may be used afterwards to track problems or surface features over time in relation to model type or environmental site conditions. This allows an improved scoping and prediction of potential problems at the components or at the whole wind turbine.

The UAV may provide additional data during the inspection is done. For example an infrared imaging or a thermal imaging may be done by arrangements which are positioned at least partially asides the UAV.

Even image overlays, computer vision, rangefinders and 3D scanner-capabilities may be used during the inspection is done.

For example when a wind turbine is operating there is a visible heat pattern within cracks in the blades of the wind turbine. This heat pattern is detected by an infrared-camera or by a thermal-camera.

The UAV, which is equipped with the infrared/thermal camera, takes high resolution images of the blade surface while the turbine is running or immediately after the wind turbine was stopped. Thus time is saved for the inspection as it is started immediately, while the wind turbine comes to a stopped-operation-mode stepwise.

Even the blade-root end or the whole blade-root-area may be scanned while the blades are turning, detecting possible cracks there.

The method may provide for a reducing in inspection time and may provide for an increase in efficiency. The automated method for inspection as described above is four times faster than technicians may work while they are inspecting the components according to the prior art. Relevant and problematic components like blades may be inspected regularly and with only a small amount of inspection-time needed.

The method may provide for a reduction in service-personal. Only a single technician is required.

The method may provide for easier documentation. As described above the documentation may be done as “self documentation” thus all gathered pictures or images or videos, etc. are referenced and loaded into a database automatically and thus without contribution of the technician. All gathered information of the inspection-scans is available for post-defined searches.

The method provides for a reduction to the risks for the personal used. The technicians may remain on the ground instead of climbing or rappelling at the wind turbine.

The method may provide for an augmented vision. The UAV allows an enhanced vision. Thus there is a high potential that even small damages may be detected by the technician.

The method may provide a “forecast of potential damages” for known components. The observation- or inspection-data are stored in a database regularly. Thus they may be used for the prediction of damages which might occur in the future.

### BRIEF DESCRIPTION OF THE DRAWINGS

The figures show specific embodiments and are not meant to be limiting.

FIG. 1 illustrates a guiding an Unmanned Aerial Vehicle.

FIG. 2 shows two possible UAV to be used.

### DETAILED DESCRIPTION OF INVENTION

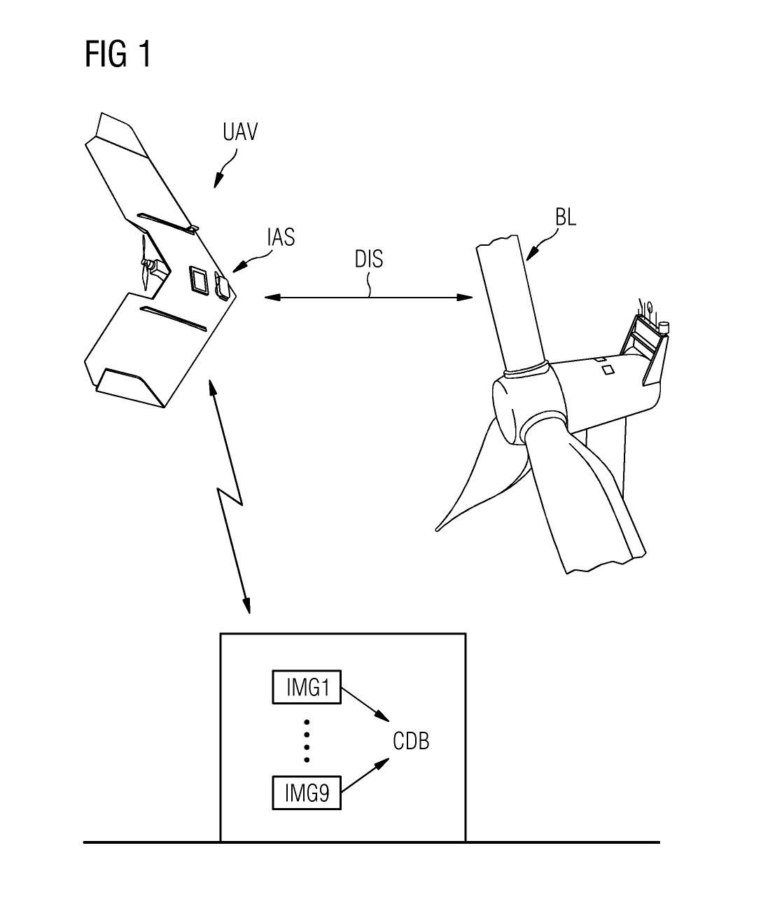

FIG. 1 illustrates an Unmanned Aerial Vehicle UAV guided towards a wind turbine component—in this case towards a blade BL.

A certain and predefined distance DIS between the unmanned aerial vehicle UAV and the blade BL is chosen in a way that high resolution images IMG1-IMG9 of the component are gathered by the unmanned aerial vehicle UAV. The images IMG1-IMG9 are gathered by an image acquisition system IAS. The inspection is done remote controlled and based on the images IMG1-IMG9, which are gathered by the UAV.

The images IMG1-IMG9 or resulting image-data IMG1-IMG9 are transferred and stored in a central database CDB, which may be arranged remotely from the unmanned aerial vehicle UAV.

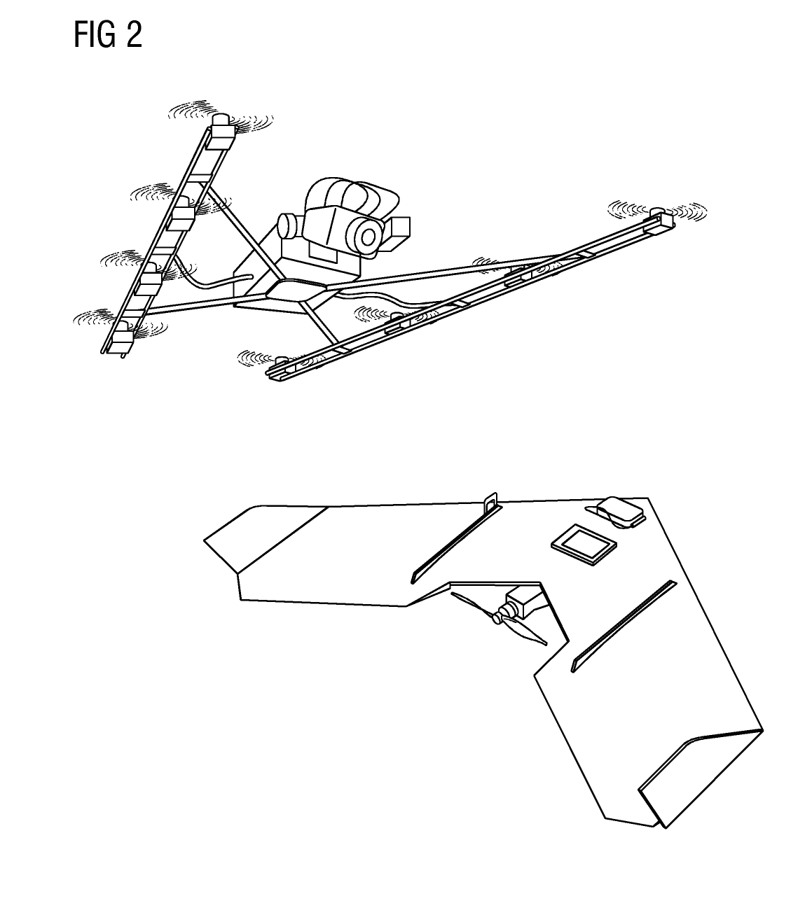

FIG. 2 shows two possible UAV to be used. One is named “Falcon-PARS”, a kind of helicopter which is offered by the company “ISTS Americas Corporation” for example. The other one is a plane, offered by the company SENSEFLY, Switzerland.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A method to inspect a component of a wind turbine, comprising:
guiding an unmanned aerial vehicle to the component for the inspection; and
choosing a certain predefined distance between the unmanned aerial vehicle and the component so that high resolution images of the component are gathered by the unmanned aerial vehicle,
wherein the images are gathered by an image acquisition system, and
where the guiding is controlled remotely and based on the high resolution images, which are gathered by the unmanned aerial vehicle.

2. The method according to claim 1,
wherein at least a portion of the image acquisition system is on the unmanned aerial vehicle for the inspection.

3. The method according to claim 1,
wherein an image acquisition system is provided on the unmanned aerial vehicle to generate and gather the high resolution images, and wherein the image acquisition system is selected from an optical camera system, an ultrasonic system, a high-frequency system, an infrared camera system, a thermal camera system and combinations thereof.

4. The method according to claim 1,
wherein data of the high resolution images is transferred and stored in a central database.

5. The method according to claim 4,
wherein the central database is remotely located from the unmanned aerial vehicle.

6. The method according to claim 4,
wherein the transfer is done wireless.

7. The method according to claim 4,
wherein the data is stored using an automated-self-documentation.

8. The method according to claim 4,
wherein portions of the data are saved to the central database automatically and according to a set of predefined rules for the tracking of surface-problems over time.

9. The method according to claim 1,
wherein the control of unmanned aerial vehicle is remote from the unmanned aerial vehicle.

10. The method according to claim 9,
wherein unmanned aerial vehicle autonomously controlled.

11. The method according to claim 1,
wherein the unmanned aerial vehicle is autonomously controlled remotely for taking off, the guiding, and landing of the unmanned aerial.

12. The method according to claim 11,
wherein GPS-data is used for the controlling.

13. The method according to claim 1, comprising:
detecting damages at the component automatically via the gathered high resolution images.

14. The method according to claim 1,
wherein a computer is used asides the unmanned aerial vehicle to detect damages at the component automatically via the gathered high resolution images.

15. The method according to claim 11,
wherein detected damages are highlighted within an image-stream or within a video, which is transferred from the unmanned aerial vehicle.

16. The method according to claim 1, comprising:
detecting heat patterns of cracks in blades of the wind turbine by a infrared or thermal camera.

17. The method according to claim 1, comprising:
wherein the surface of the component is inspected.
